(19) United States
(12) Patent Application Publication
(10) Pub. No.: US 2014/0052598 A1
(43) Pub. Date: Feb. 20, 2014

(54) REAL-TIME TRADING AND PURCHASING OF VALUE DOCUMENTS

(71) Applicant: xTradeSoft GmbH, (US)

(72) Inventor: Michael Briem, Monaco (MC)

(73) Assignee: xTradeSoft GmbH, Wien (AT)

(21) Appl. No.: 13/760,395

(22) Filed: Feb. 6, 2013

Related U.S. Application Data
(60) Provisional application No. 61/595,929, filed on Feb. 7, 2012.

(51) Int. Cl. G06Q 40/04

(52) U.S. Cl. CPC G06Q 40/04
USPC 705/37

(57) ABSTRACT

This disclosure describes a system for real-time trading and purchasing of value documents. Described is providing access over the internet with a device to a registry server with a registry database. Next, described is setting up a registry for a plurality of value documents. Further described is the registration of owners and their value documents in a log file. And further described is keeping entries of the registered value documents. Next described is the opening an e-wallet account by a buyer that defines an exit account and then verifying it. Further described is interconnecting the e-wallet, the registry and the exit account. Additionally described is the pre-order validation of all orders. And, then described is the trading and settlement of funds and the value documents between the owner and the buyer. And then described is updating and recording information when a trade of the documents is executed.

### CROSS REFERENCE TO RELATED APPLICATIONS

This application claims priority and the benefits of the earlier filed Provisional USAN 61/595,929, filed 07 Feb. 2012, which is incorporated by reference for all purposes into this specification.

### TECHNICAL FIELD

The present invention relates to a method and a system for real-time trading and purchasing of value documents.

In particular the present invention provides a method for trading securities, preferably shares, but also registered bonds and rights to buy new shares etc. of companies not yet traded or listed on any exchange.

Further, the present invention relates also to a method for real-time trading and purchasing of event tickets.

Further, the present invention relates also to a method for trading memberships, in particular golf club memberships.

### BACKGROUND ART

### i) Securities

The term “securities” includes also without limitation equities, stocks, bonds, rights to buy new issued shares, warrants etc.

Traditional stock trading of an unlisted company is executed in larger blocks as a larger percentage of outstanding share capital. Security transfer and integrity of the share certificates are normally handled by contractual obligations. The more companies receive venture and business angel financing the more the shareholder basis broadens. Buying and exit routes for existing owners are required before the company may go public or get sold in a trade sale. Trading of these instruments is actually quite difficult, as banks and brokers do not like to be involved in these transactions as information and back office handling is difficult and time consuming also due to the limited infrastructure of such small companies.

Traditional trading in not—at an exchange—listed, but traded companies is organized by dealers offering non-binding buy and sell quotes. Trading is executed via phone, and then the dealer requires cash against security settlement with a bank or broker via a central clearer.

Only if the central clearer, as e.g. DTC (Depository Trust Corporation) in the US, Sega/Sic in Switzerland or Euroclear in Germany is willing to accept these securities for clearing such trading can be executed.

Some markets as the US market with the Pink Sheet market, or in Switzerland with the OTC trading of the Berner Kantonalbank have a trading facility for not exchange listed shares, but many companies lack a suitable infrastructure and involve high transaction costs for the buyers and sellers of such securities so that trading in these instruments is normally not recommended. In the US market the spread, i.e. difference between the dealers buy and sell price based on a percentage basis may be one third of the transaction value. A dealer may buy a share for 10 cent per share and the same dealer is only willing to sell for 15 cent per share. With this kind of spreads no reasonable investment can be made.

With the advent of the Internet, in particular services like eBay, buyers and sellers find a large market to trade a lot of physical goods. No such infrastructure has been invented for securities markets as the bottleneck was always clearing and settlement.

It is one object of the invention to overcome the aforementioned disadvantages and to provide a method which allows to identify owners of already owned securities and to trade securities without intermediation of a bank or a broker on an electronic exchange.

### ii) Tickets

The term “tickets” includes without limitation football, soccer, basketball tickets etc. and theatre, opera tickets etc. and also similar value documents, e.g. green fees.

Traditional event tickets are in bearer form allowing the owner to use/sell them close to his/her environment and ticket fraud has not been a big problem. Buyer and seller must be physically proximate to physically transfer the ticket(s).

With the advent of the Internet, in particular eBay, buyers and sellers find a large market to trade tickets, but with a high risk of fraud. However, the paper ticket still stands as an impediment to the efficient transfer of the right to attend an event, because the seller must ship the ticket to the buyer. By shipping the ticket, the buyer and seller have to bear additional costs and acquire a greater lead-time to allow the transfer before the event. Each party must also have enough trust that the other party will deliver as agreed.

Event organizers, in particular soccer game organizers, face the problem of excluding participants of the event who were involved in violent actions during previous events. This created the demand to shift from the issuance of bearer tickets to register tickets. Terms and conditions of high-grade soccer events prohibit the trading/reselling of the tickets for a price above the face value.

Event organizers, organizing events only once a year, such as summer festivals in Bayreuth, Germany and Salzburg or Bregenz, Austria etc., sell tickets long before the event starts and therefore create a demand for a secondary market due to unclear time constraints of the individual ticket purchaser.

It is a further aim of the invention to provide a method which offers great flexibility for those purchasing tickets long in advance, allowing easy trading and guaranteeing the integrity of all tickets for a purchaser of a ticket via the secondary market.

iii) Memberships, in Particular Golf Club Memberships

Normally the manager of the club is contacted to which the member belongs. The membership is verified, and the office is informed that the member intends to sell his membership. The management office might maintain a waiting list with individuals looking to buy, in order to make the sale easier. It is a further aim of the invention to provide a method to determine a reasonable price for a membership allowing easy trading of the membership.

### iv) General

The present invention provides real-time trading and purchasing of registered value documents registered only via book records.

According to the invention the method comprises the following:
providing access over the internet with an electronic device to a registry server with a registry database
setting up or taking over a registry for the plurality of value documents
registration of value document owners and their value documents in an electronic log file
keeping book entries of the plurality of registered value documents
opening an e-wallet account by a buyer comprising funds and thereby defining an exit account and verifying the exit account by a control authority
interconnecting the e-wallet, the registry and the exit account
pre-order validation of all orders by blocking value documents and funds during the time period the order is pending to avoid any settlement risk for buyers and sellers
trading and interconnected real time settlement of funds and of one or a number of the plurality of registered value documents between the value document owner and the buyer,
wherein, when a trade of one or a number of the plurality of registered value documents is executed, the respective book entry is updated with respect to the new owner and a confirmation document is issued to the new owner, which documents that at a date stamped he is recorded in the registry.

The seller receives a corresponding information that the cash resulting from the sale has been credited to his account.

With this invention worldwide trading of value documents can be accomplished.

According to one embodiment of the invention the value documents are securities, in particular shares, and the registry is a share registry.

By handling only the share registry on behalf of a company the organizer of this market does not need a bank license so he may organize the trading on a worldwide platform. The integrity of the share registry for each party is secured by only accepting book entries. Each order is pre-validated before entering the order book. A matching infrastructure is offered without involving a spread of the market Maker and a real-time settlement of matched orders of buyers and sellers is accomplished. Further, a centralized service for security data integrity and the shareholder information, i.e. information of shareholder consolidation, rights issues, share dividend scheme is offered centrally by the transfer agent operating the exchange.

According to another embodiment of the invention the value documents are tickets and the registry is a ticket registry.

The purchaser is provided with a ticket only as a confirmation receipt of his book record entry at the ticket registrar. By selling his ticket in the secondary market at the electronic exchange, the integrity of all tickets is guaranteed and the provider of the electronic exchange can guarantee the fulfillment and is able to issue a new ticket purchase confirmation substituting the old ticket purchase confirmation in the name of the new purchaser.

With the invention participants may be excluded in the primary as well as in the secondary market. The operator may further limit the sales price on the secondary market to face value or may include a profit participation on behalf of the event organizer in the profit generated in the secondary market.

With this invention purchasing tickets long in advance constitutes no problem since the tickets can be easily traded in the secondary market. The event organizer may sell many more tickets in advance as potential purchasers may buy the tickets for attending the event but also for speculating with the resale of the ticket.

According to another embodiment of the invention the value documents are memberships and the registry is a membership registry.

Further embodiments of the invention are described in the description.

### SUMMARY OF INVENTION

This disclosure describes a Real-Time Trading And Purchasing Of Value Documents. The first step includes providing access over the internet with an electronic device to a registry server with a registry database. Next, the disclosure provides setting up or taking over a registry for a plurality of value documents. Further included is the registration of value document owners and their value documents in an electronic log file. And, further included is keeping book entries of the plurality of registered value documents. Next, the disclosure provides that opening an e-wallet account by a buyer comprising funds and thereby defining an exit account and verifying the exit account by a control authority. Further included is the interconnecting the e-wallet, the registry and the exit account. Additionally included is the pre-order validation of all orders by blocking value documents and funds during the time period the order is pending to avoid any settlement risk for buyers and sellers. And, further included is the trading and interconnected real time settlement of funds and of one or a number of the plurality of registered value documents between the value document owner and the buyer. Additionally included is when a trade of one or a number of the plurality of registered value documents is executed, the respective book entry is updated with respect to the new owner and a confirmation document is issued to the new owner, which documents that at a date stamped he is recorded in the registry.

This disclosure further provides that where a confirmation is sent to the value document owner who as a seller sold one or a number of the plurality of registered value documents confirming his sale and the receipt of the funds in the e-wallet or directly in the exit account stamped with the date. And the disclosure further provides that after the e-wallet account is opened reconciliation with the share registry is performed and thereafter the e-wallet, the share registry and the exit account are all interconnected and trading may be performed. The disclosure further provides that when the e-wallet account is opened and activated the buyer may enter order details via a communications network.

This disclosure further includes that the value document owners are registered by recording their first name, family name, address and date of birth. The disclosure further includes that the buyer defines the exit account by providing his first name, family name, address and date of birth, and the exit account is verified by checking this data supplied by the buyer against a database of a credit validation company. And the disclosure further provides that if more than one person with the same first name is recorded in the database of the credit validation company a further age check is performed, and if the credit validation company verifies the age of the account holder, the account opening of the e-wallet account is executed.

This disclosure further includes that validated and checked orders are entered in an order book, where all buy and sell orders are consolidated for a specific price and if orders for the same price are already placed, the earlier order for the same price is first executed, then the later one. And the disclosure provides that if the order is a buy order, it is checked whether in the e-wallet there is sufficient funds and the corresponding funds are blocked, or if the order is a sell order, a check against the holdings of the seller takes place and part of the holdings corresponding to the sell order is blocked during the lifespan of the order.

This disclosure further provides that value documents are securities, securities are shares, and the registry is a share registry. Additionally, this disclosure provides that a transfer instruction for ownership change is received from a central clearing institution or directly from the shareholder and the transfer instruction is matched with the registry entries and if the transfer instruction corresponds to the registry entries the transfer instruction is executed and the share registry is updated. And, this disclosure further provides that if a match is available, the share registry is updated by reducing the shares of the seller and adding the share purchase of the buyer to his holdings in the register, and the purchase price of the transaction is debited in the e-wallet account of the buyer and credited in the account of the sellers and the confirmation documents are sent to the seller and the buyer.

This disclosure further provides that the value documents are tickets and the registry is a ticket registry. Additionally, the disclosure provides that if a match is available the ticket registry is updated by reducing the tickets of the seller and adding the ticket purchase of the buyer to his holdings in the registry, and the purchase price of the transaction is debited in the e-wallet account of the buyer and credited in the account of the sellers and the confirmation documents are sent to the seller and the buyer.

This disclosure further provides that the value documents are memberships, in particular golf club memberships and the registry is a membership registry.

### DESCRIPTION OF DRAWINGS

To further aid in understanding the disclosure, the attached drawings help illustrate specific features of the disclosure and the following is a brief description of the attached drawings:

FIG. 1 shows a flow diagram of a part of an embodiment of the invention;

FIG. 2 shows a flow diagram of a further part of the embodiment according to FIG. 1;

FIG. 3 shows a flow diagram of a further part of the embodiment according to FIG. 1;

FIG. 4 shows a flow diagram of a part of a further embodiment of the invention;

FIG. 5 shows a flow diagram of a further part of the embodiment according to FIG. 4;

FIG. 6 shows a flow diagram of a further part of the embodiment according to FIG. 4;

FIG. 7 shows an embodiment of the invention;

FIG. 8 shows another embodiment of the invention;

FIG. 9 shows another embodiment of the invention;

FIG. 10 shows another embodiment of the invention;

FIG. 11 shows another embodiment of the invention;

### DESCRIPTION OF EMBODIMENTS

This disclosure describes a real-time trading and purchasing of value documents. This disclosure describes numerous specific details in order to provide a thorough understanding of the present invention. One skilled in the art will appreciate that one may practice the present invention without these specific details. Additionally, this disclosure does not describe some well known items in detail in order not to obscure the present invention.

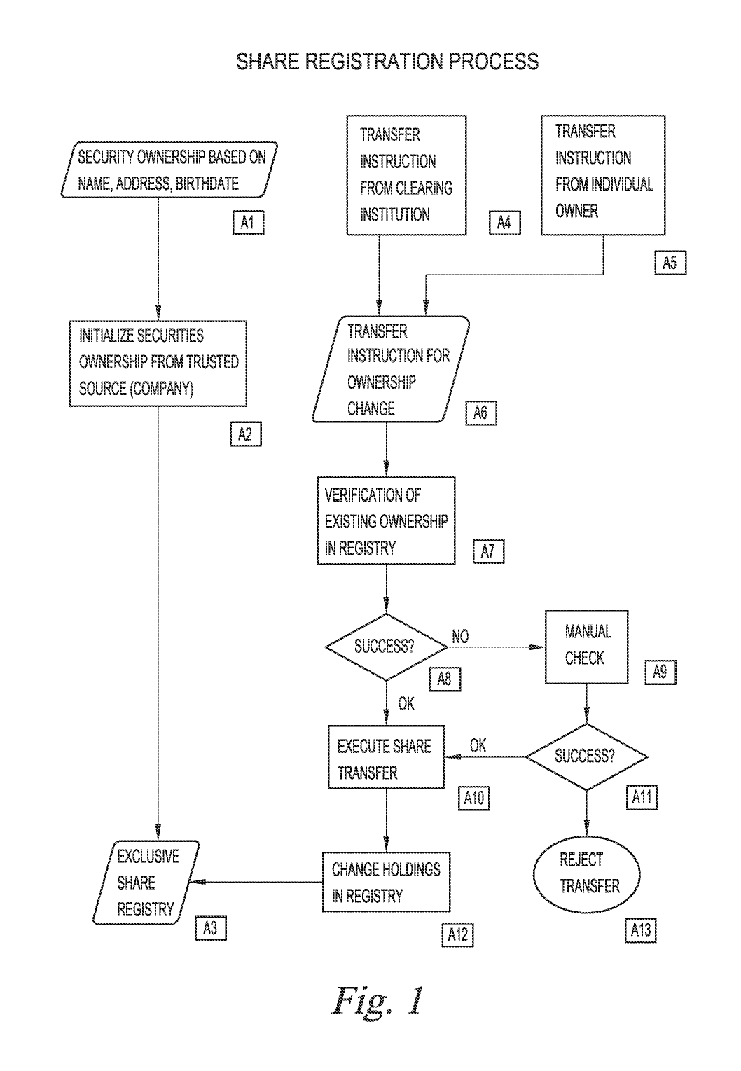

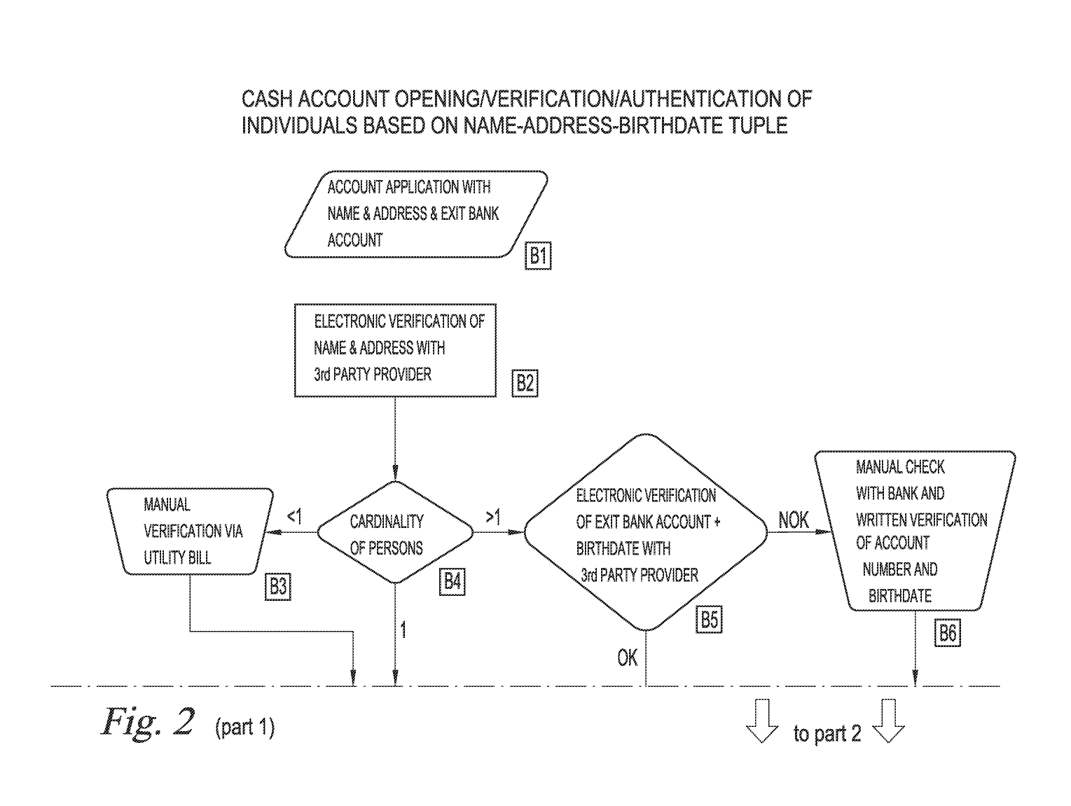

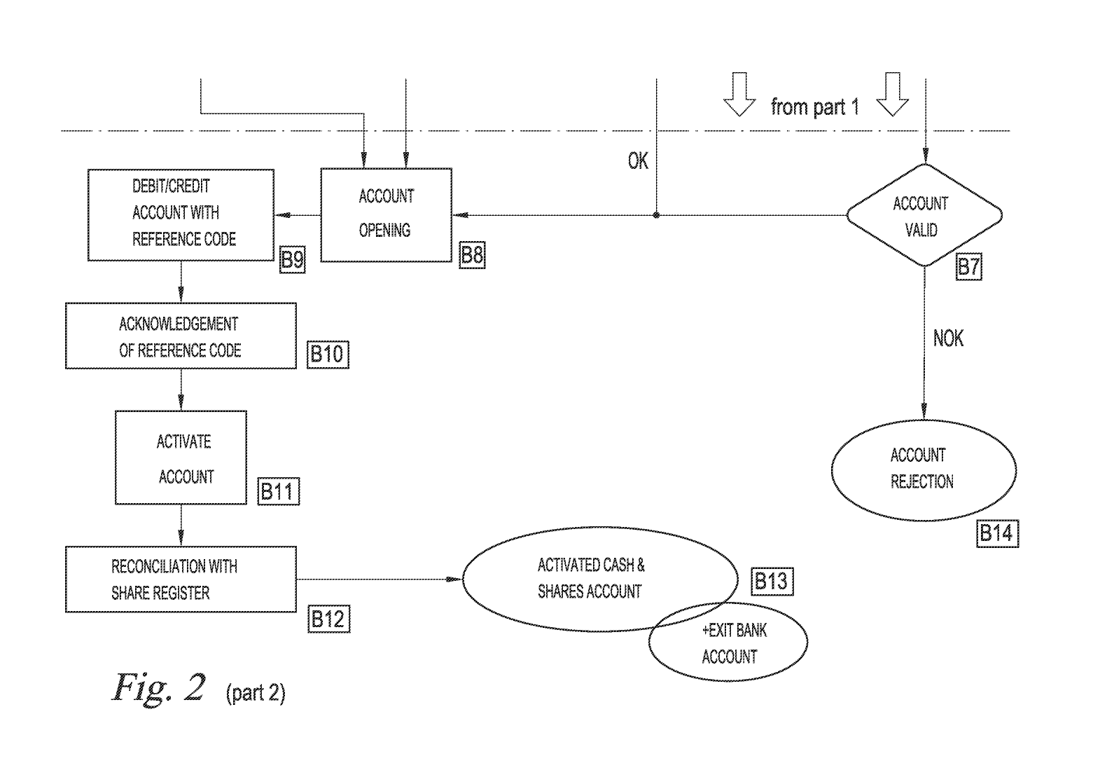

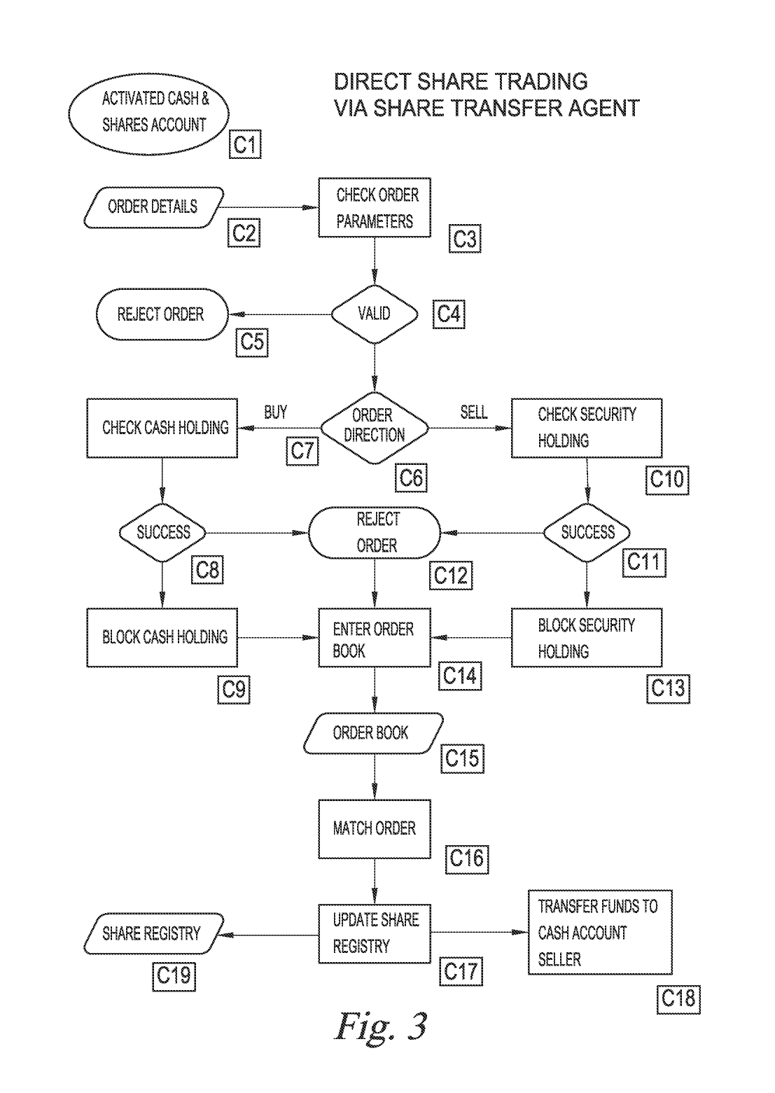

In FIG. 1, FIG. 2 and FIG. 3 an embodiment of the invention is shown based on value documents being shares of an unlisted company.

FIG. 1 shows a process of a share registration, including the steps of setting up or taking over a registry for a plurality of shares, registration of share owners and their shares in an electronic log file and keeping book entries of the plurality of registered shares.

A registered shareholder has bought shares from a company directly and has been registered there. As the number of shareholders has grown the company decides to outsource the handling of a share registry to a qualified service provider.

A1, A2, A3: The first name, family name, address and birth date and a description of the shares as holdings are transferred from a trusted source into a share registry.

A4, A5: This process is executed if a dealer trades shares with a broker in non-listed securities, which are allowed to settle via a Central Depository Trust.

If the shares of not exchange listed companies are traded, the transfer agent receives an instruction for ownership change via a central clearing institution (A4) or an individual instruction of the recorded owner (A5).

A8, A10, A12: The instructions are matched with the registry holdings and if the instruction corresponds with the recorded holding the instructions are executed and the share registry is updated.

A9: If the instructions cannot be processed automatically because one of the required data is not correctly represented, manual processing has to be performed.

A11: If the data are correct the share transfer is executed.

A11, A13: If the data do not correspond with the records the instruction is denied.

The cash account opening, verification and authentication of individuals is based on first name, family name, birthday and address tuple.

If a shareholder would like to transfer shares to his children or would like to buy shares or sell part or all of his holdings, he needs to identify himself to the transfer agent so that the holdings can be aligned to him as the identified owner.

The invention defines a unique way to sort this out based on a purely electronic way—without requiring a post-identity authentication—which means that only the real beneficial owner may act on behalf of the holdings held in his name.

This is difficult to organize as identity cards may be copied or stolen and there may be more than one person living at the very same address. If father and son live in the same house it is very difficult to verify if the person opening the account is the same, who is incorporated in the share register, as first name, family name and address are the same. Only the verification of the age can define the required authentication.

FIG. 2 shows a process for cash account opening, verification and authentication of a buyer based on name-address-date of birth tuple.

B1: A customer, i.e. a seller or a buyer, willing to participate in an electronic direct trading has to open via Internet on a web page an e-wallet account with an e-money institution associated with the transfer agent. Integral to this process is to define an already existing bank exit account. The customer enters his first name, family name, address and his date of birth.

B2: The first process is to check this data supplied by the customer against a database of a credit validation company, e.g. SCHUFA Holding AG in Germany.

The check by the credit validation company may result in:

B3: No record is available. If the customer just changed his address and did not update his bank address details, a manual verification of the address via a utility bill has to be applied.

B4, B8: Only one record is available meaning that one person with the same first name lives at this address. In this case no further name verification has to be performed.

B5, B8: If more than one person with the same first name is recorded in the database a further age check has to be performed associated with the exit bank account. The credit validation company allows verifying the account number of the customer and the age. If the supplied data for the exit account correspond with the credit validation company and if the credit validation company verifies the age of the account holder account opening procedure is processed.

B6, B8: If the credit validation company does not supply the data, the bank operating the exit bank account of the new customer has to confirm that the account holder with the first name, family name, address and age is the account holder of the exit account.

B14: If the exit bank cannot confirm this, the opening of the e-wallet account is rejected .

B9, B10: A small amount of funds is either credited or debited to the exit bank account with a reference code. This reference code has to be copied by the account holder into the account opening form.

B11: If the code is confirmed by the customer the exit account is linked with the e-wallet and the e-wallet account may be activated.

B12: After the account is opened reconciliation with the share registry has to be performed so that all holdings of a certain share owner may be aligned with the e-wallet. If address changes are not yet incorporated in the share registry this has to be manually corrected by providing a utility bill or identity cards with the previous address.

B13: After this process the e-wallet, the share register and the exit account are all interconnected and trading may be performed.

FIG. 3 shows direct share trading via a share transfer agent:

C1, C2: When the e-wallet account is open and activated, the customer may enter order details in the web interface of the operator.

C3: Order parameters are checked as to whether they are consistent with the rules. Orders may only be entered for activated securities.

C4, C5, C6: If the order meets these requirements order direction is checked. If the requirements are not met, the order is rejected.

C7, C8, C9, C12: If the order is a buy order, the system checks if sufficient cash is in the e-wallet. If yes, it blocks the cash holdings during the life span of the order. If not sufficient cash is available, the order entry is rejected.

C10, C11, C12, C13: If the order is a sell order, the system checks if sufficient holdings of this specific security are available in the share register. If yes, the holdings are blocked, if no, the order is rejected.

C14, C15: Validated and checked orders are then entered in the open order book where all buy and sell orders are consolidated for a specific price. If orders for the same price are already placed, time priority is established; meaning that the earlier order for the same price is first executed then the later one.

C16, C17, C18, C19: If a match is available, the share registry is updated by reducing the shares of the seller and adding the share purchase of the buyer to his holdings in the share register. The purchase price of the transaction is debited in the account of the buyer and credited in the account of the seller and two confirmations, one for the seller and one for the buyer, are sent via e-mail to each involved party.

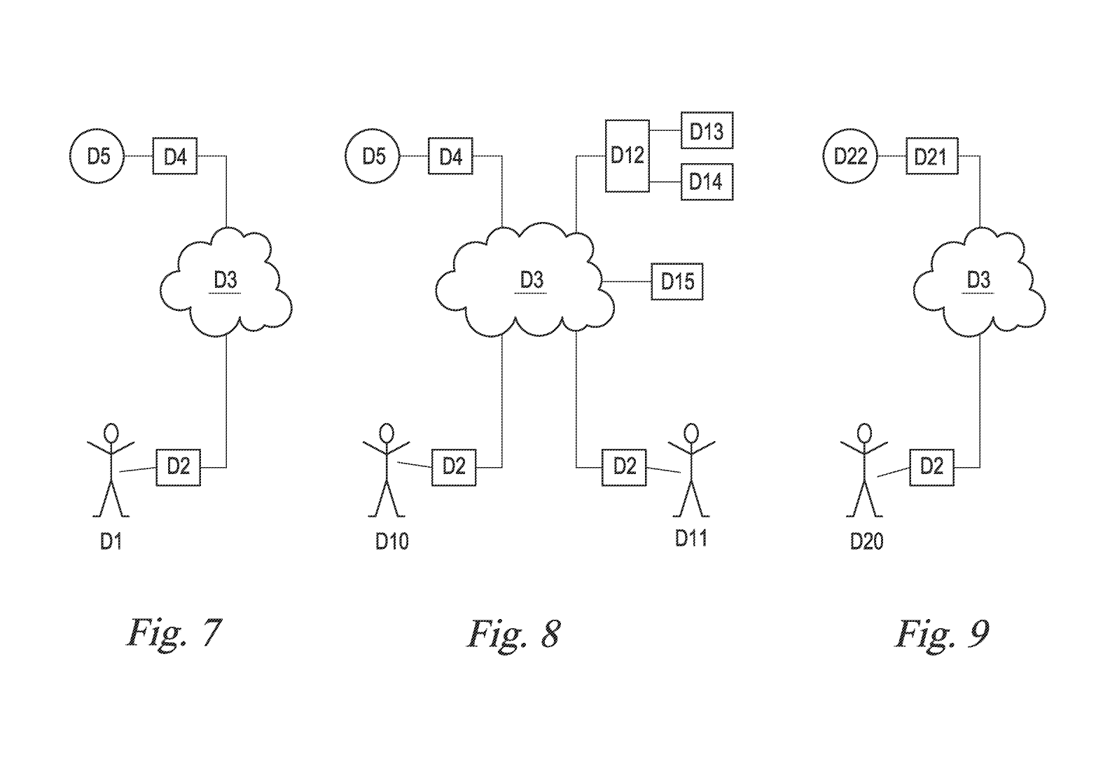

A system for implementing an embodiment of the invention for share trading is shown in FIG. 7. The system works with a world wide network D3, in particular the internet and has an electronic device D2 capable of connecting to the internet, e.g. a smart phone, or a workstation or a computer. A registered shareholder D1 can access over the internet with the electronic device D2 to a share registry server D4 with a share registry database D5. The shareholder D1 and his shares are registered in an electronic log file. Book entries of the plurality of registered shares are kept.

In FIG. 8 the system of FIG. 7 is shown with two registered shareholders D10 and D11 who are capable of connecting to the internet D3 with their electronic devices D2. D12 is an e-money financial institution server with one or more e-wallets D13, D14. Shareholder D11 offers shares and acts as a seller whereas shareholder D10 desires to buy shares and acts as a buyer. Shareholder D10 opens an e-wallet D13 account comprising funds and thereby defining an exit account and verifying the exit account by a control authority constituted by a credit validation company server D15. During the buying process the e-wallet D13, the registry and the exit account are interconnected. Additionally included is the pre-order validation of all orders by blocking shares and funds during the time period the order is pending to avoid any settlement risk for buyers and sellers. Further, trading and interconnected real time settlement of funds are accomplished and of one or a number of the plurality of registered value documents between the value document owner and the buyer. Additionally included is when a trade of one or a number of the plurality of registered value documents is executed, the respective book entry is updated with respect to the new owner and a confirmation document is issued to the new owner, which documents that at a date stamped he is recorded in the registry.

Instead of tickets similar value documents can be traded, e.g. green fees for a golf course, employing the system shown in FIG. 11.

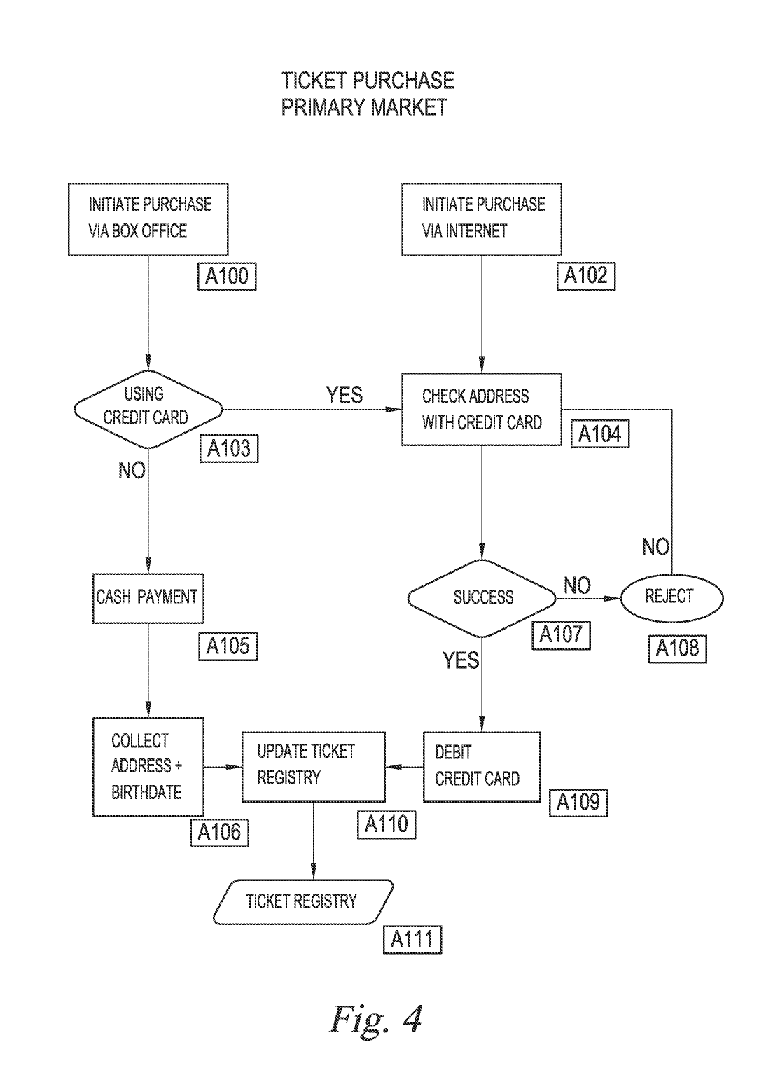

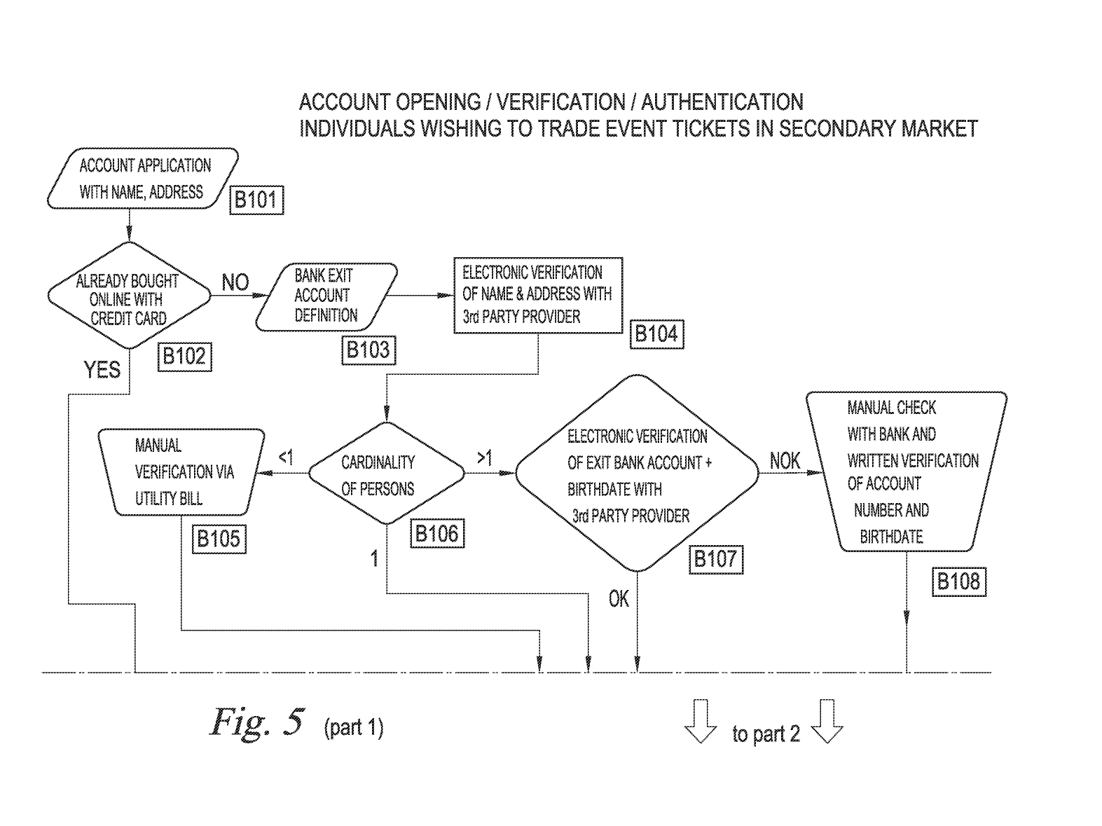

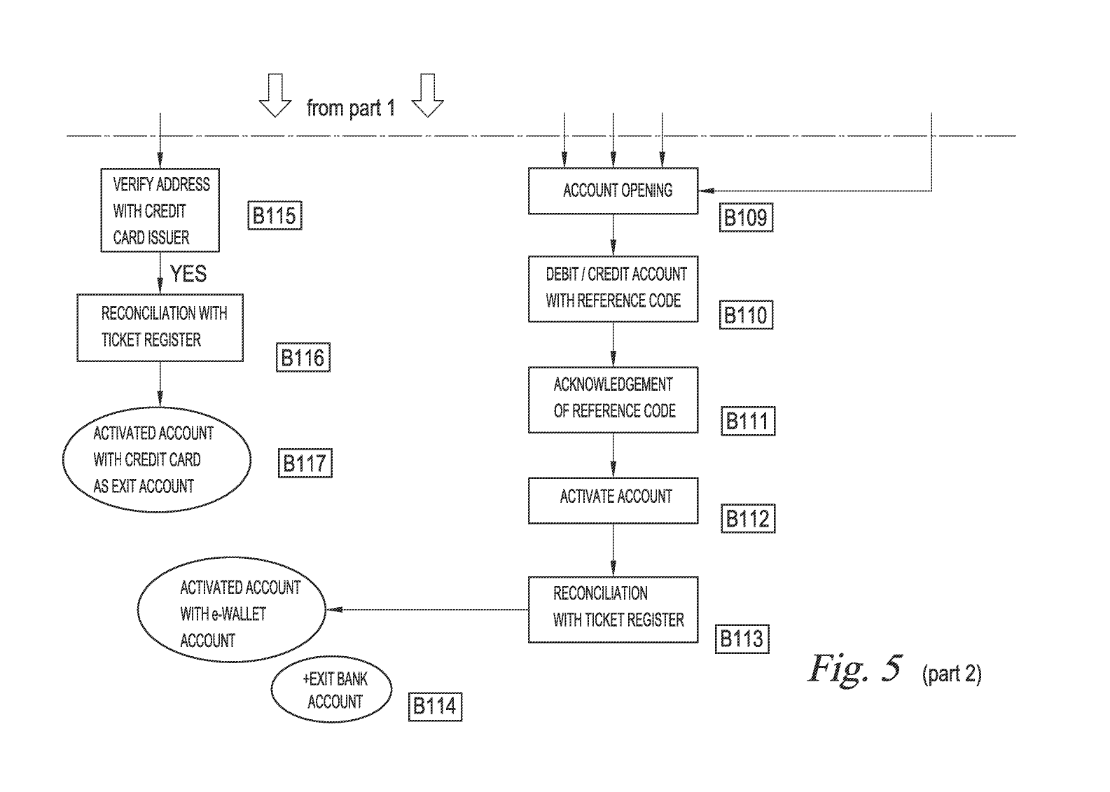

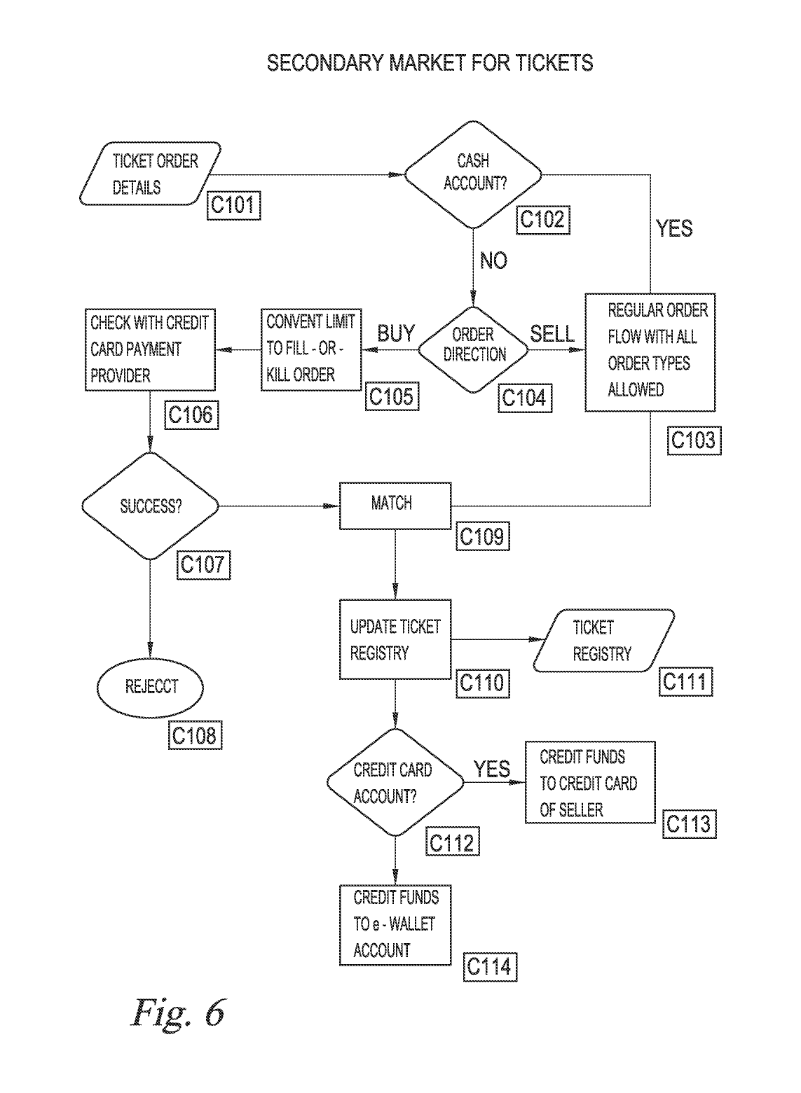

FIG. 4, FIG. 5 and FIG. 6 show an embodiment of the invention in which the security documents are tickets.

A ticket has a determined life time cycle which is tracked by a system used to implement the inventive method.

For a certain event a number of tickets are created. After the event has taken place the life cycle of the tickets ends and the tickets may stay as historic tickets in the database.

All tickets are registered in a ticket registry. Registered tickets may only be transferable via entry in the ticket registry. First, the tickets are sold in the primary market.

Tickets which could not be sold in the primary market and tickets which were already sold in the primary market are offered in a secondary market.

Purchase Confirmation:

Depending on the event there may be different options to deliver a confirmation of the ticket. The customer receives only a confirmation of the purchase which gives him the right to participate but not a transferable ticket, meaning the ticket is not transferable via endorsement, e.g. by documenting on the ticket that it has been transferred to a new owner.

The ticket may be used only with an identity card. The ticket document is only a confirmation which is not transferable to another person. It documents that the owner purchased the ticket at a specific date. If a later confirmation is available for the same event and the same seat, then this statement documents that the previous owner sold the ticket to the new owner.

If available seats are clearly defined like in an airplane, the customer receives via e-mail a confirmation of his ticket purchase with a barcode. The customer may print a copy and present this copy at the entrance. If more than one copy is presented and two persons request the same seat, then a check of date of confirmation and identity will clarify the situation. The latest ticket confirmation is the valid one and if two copies of the same tickets have been printed, only the person with the right identity may have the right to use the seat then.

If the event offers seated and non-seated tickets, ticket confirmation will be printed with an RFID chip so that the ticket confirmation cannot be copied. If the ticket is sold in the secondary market the system will deactivate the previous ticket purchase confirmation and issue a new ticket purchase confirmation with a new date. Tickets with RFID chips ensure that the operator can check that only the latest owner of the ticket enters the event with only one copy of the purchase confirmation.

At the venue a reading device, e.g. a scanner, a RFID antenna etc. can be arranged which is connected via a data connection to the registry. The data on the ticket confirmation can be compared with the registry data and thus it can be decided whether the ticket confirmation is in accordance with the updated ticket data in the registry.

FIG. 4 shows the process of purchasing a ticket registered in a ticket registry in the primary market including the steps of setting up or taking over a registry for the plurality of tickets, registration of ticket owners and their tickets in an electronic log file and keeping book entries of the plurality of registered tickets.

A100, A102: To implement this invention a consumer can access a data centre either by contacting a box office or via Internet with an interface, e.g. on his fixed line computer or his mobile phone. If he surfs the Internet, he can view the calendar of events of an event organiser, search for a desired event or choose a venue to see what events will be appearing at the venue in the future. After choosing an event an Internet sale is normally paid via credit card, a box office sale may be paid by cash or with a credit card.

A103: If the costumer chooses a box office purchase and he is using a credit card, the process is very similar to standard handling of a ticket purchase. The costumer has to supply additionally an address so that the operator may book the address in the ticket registry in order to identify the customer if he returns to sell his ticket later.

A104, A107, A109, A110, A111: The address supplied by the customer is checked as well as the availability of funds via the credit cards acquiring infrastructure. If address and funds are confirmed the credit card is debited and the ticket registry is updated.

A105: If the customers pay cash at the box office counter, the clerk has to ask for the address and the date of birth.

A106, A110, A111: Personal data are stored in the database, then the ticket registry is updated and the ticket confirmation is printed. Personal data are necessary to identify the customer if he returns to sell the ticket in the secondary market.

FIG. 5 shows the process of opening an account for the secondary market. This account may be opened in order to purchase a ticket the first time, to purchase another ticket or to sell an existing—previously purchased—ticket.

B101: A customer intends to purchase a ticket for an event of his interest and opens a web page with an application form, entering his name, address and date of birth.

B102: The customer is asked by the system if he already purchased a ticket for the targeted event with a credit card.

B115: If the customer already paid with the credit card the customer account opening could be organised in a simplified way as there is an account already available for crediting or debiting funds. The system verifies the address of the customer with the credit card issuer.

B116: The system checks with the ticket registry the ticket holdings of the customer and combines cash account with ticket holdings.

B117: A customer account with a credit card as purchasing and debiting infrastructure is activated.

B103: A customer with no credit card has to open an e-wallet account and define an exit account with a third bank and align this account with his ticket holdings.

B104: If the system has only the name, address and date of birth, it is crucial to build up an infrastructure to authenticate a customer and make sure that tickets of a third person are not aligned to a wrong customer. The system works with a credit validation company, e.g. SCHUFA Holding AG in Germany, a company for the credit history of customers, an electronic verification of name and address.

B106: The result has to proof the cardinality of the persons and shows that:
i) B105: No customer is living at this address. In this case the customer has to send the operator a scanned utility bill to document the existence of the address.
ii) One person with the same name is living at the address.
iii) B107: More than one person with the same first name and family name is living at this address. In this case a second verification with a credit validation company has to be initiated in order to check the exit bank account number plus the birth date. As the credit validation company offers a check of account numbers and date of birth the system knows which of the family members with a specific birth date is involved.

B108: If the electronic check with the credit validation company fails, the customer has to ask his bank for a written confirmation that the person with the required personal data, namely first name, family name, defined address and birth date, has an account with the bank with a number which corresponds to the exit

B110, B111, B112: Now a verification process is initiated by debiting or crediting a small amount of money to the exit bank account with a reference code. The customer has to copy the reference code of the bank statement into an account opening form thereby confirming that he is the person who has access to this account. Combined with the age verification the cardinality of the person, the authentication can be performed.

B113: After the authentication of the person has been defined a reconciliation with the ticket registry is performed and already purchased tickets are grouped with a customer account.

B114: The customer account is activated with an e-wallet and an exit bank account for the transfer of funds generated by the sale of tickets.

FIG. 6 shows the way tickets are traded and settled in the secondary market. As all tickets are registered in the ticket registry there are several options for the event organiser to control the ticket trading in the secondary market. The ticket trading in the secondary market is grouped in classes of tickets with the same price and allows the trading of the tickets comparable to the share trading.

A new order form can be implemented, as many potential buyers are only interested if they can buy two tickets for seats next to each other to allow a “double seat only” limit order.

In events highly in demand the event organiser may use this trading facility also for the primary market by offering all tickets either in a normal auction for a fixed price but with limited quantity or in a “Dutch Auction”, where the highest bidder gets the tickets at the price where the last tickets could be sold. All tickets in the primary market are sold in the “Dutch Auction” with one auction. In this business case all bidders have to be registered first.

If the organiser wants his ticket to be traded in the secondary market only at face value he may limit order entries only at the face value price the ticket seller purchased the ticket at. He can implement these limitations.

If the organiser wishes to participate in the profit of the resale of the tickets this may be organised as the trading system stores in the database the primary market purchase price, can calculate the profit of the seller and can implement these specifications.

If the organiser would like to receive royalty in each secondary market transaction this can also be implemented.

C101: A customer wishing to purchase a ticket surfs through the events operator home page and evaluates the order book for the event. If he is interested in buying or selling the customer opens his activated account and enters the ticket details.

C102, C103, C104, C105: The system checks if the customer has an e-wallet account or a credit card account for clearing the transaction.

If the customer uses his credit card, he may only buy available tickets by giving an order instruction, e.g. a limited order instruction (fill or kill).

Customers with e-wallet accounts are allowed to give buy orders with a price limit not available yet. The reason for this restriction is that all orders—buy as well as sell orders—have to block the underlying—ticket or cash—so that fulfillment is guaranteed for both parties.

Execution can be performed immediately after the matching process is completed.

For credit card buyers it is not possible to block funds for a longer period. So credit card buyers are only allowed to place fill or kill buy orders. There is no such differentiation for sell side tickets.

C107, C109: If the buyer and the seller agree to the price and the buyer has a cash account the transaction is matched immediately.

If the buyer has a credit card account, a credit card check is performed, and if sufficient funds are available, the transaction is executed after confirmation of the availability of funds.

C110, C111: The ticket registry is updated by replacing the seller's name with the buyer's name.

C112, C113, C114: The purchase price is refunded to a credit card account of the seller if available. Otherwise it is booked in the sellers e-wallet account.

After the transaction is completed the buyer receives either per e-mail or per ordinary mail a confirmation that he bought the ticket.

Instead of tickets similar value documents can be traded, e.g. green fees for a golf course, employing the system shown in FIG. 11.

A system for implementing a further embodiment of the invention for real-time trading and purchasing of tickets is shown in FIG. 9. The system works with a world wide network D3, in particular the internet and has an electronic device D2 capable of connecting to the internet, e.g. a smart phone, or a workstation or a computer. An event organizer D20 can access over the internet with the electronic device D2 to a ticket registry server D21 with a ticket registry database D22. The event organizer D20 and his tickets are registered in an electronic log file. Book entries of the plurality of registered tickets are kept.

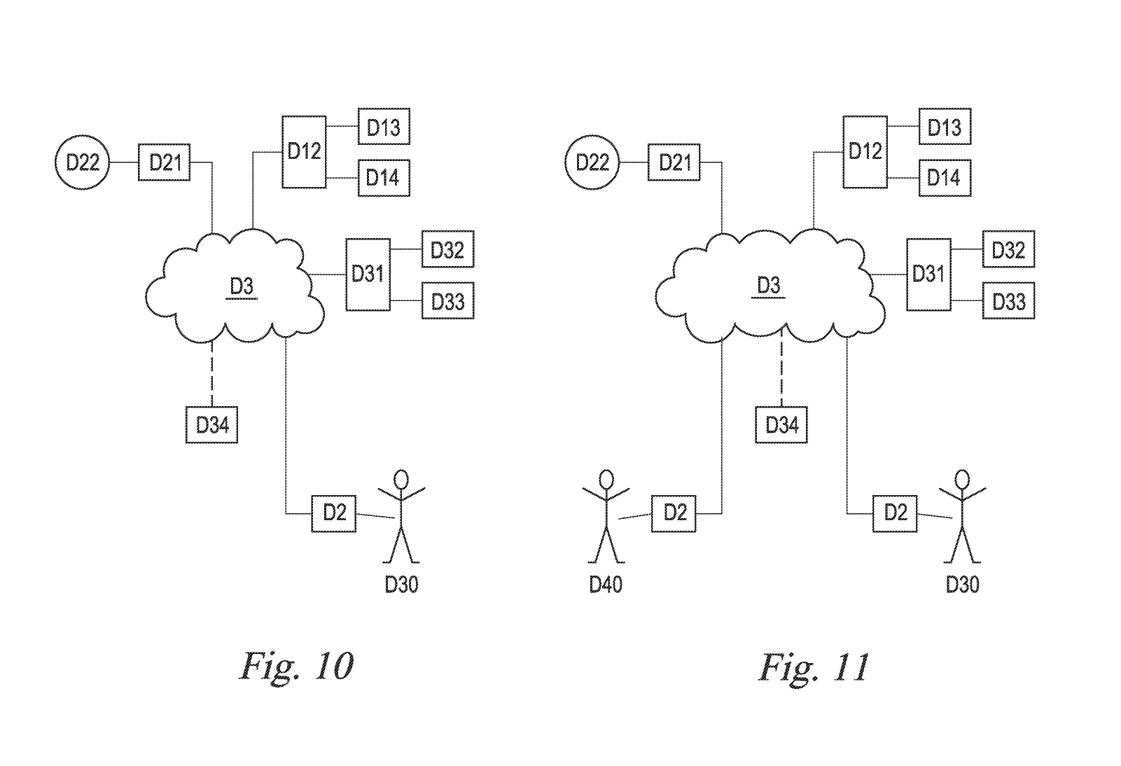

In FIG. 10 the system of FIG. 9 is shown in which a customer/buyer D30 is connected to the internet D3 via an electronic device D2. Further, an e-money financial institution server D12 having one or more e-wallet accounts D13, D14 is in connection with the internet D3. Also a credit card company server D31 and credit card accounts D32 and D33 are accessible via the internet. The customer/buyer D30 who wishes to purchase a ticket D34 evaluates the order book for the event. The system checks if the customer/buyer D30 has an e-wallet account or a credit card account for clearing the transaction.

In the embodiment of FIG. 11 a seller D40 agrees to the price of the ticket and if the buyer has a credit card account, a credit card check is performed, and if sufficient funds are available, the transaction is executed after confirmation of the availability of funds. Alternatively the purchase price is booked in the sellers e-wallet account. The purchase price is refunded to a credit card account of the seller if available. Otherwise it is booked in the sellers e-wallet account.

After the transaction is completed the buyer receives either per e-mail or per ordinary mail a confirmation that he bought the ticket.

Often data protection law stipulates storage of data within the borders of the respective country thus the transfer of data to a foreign country is restricted. In order to refer to the registration of a value document owner and his value documents abroad the customer data without personal data together with a login and a password are stored additionally in a database located in a country without strict data protection. The user can access to the anonymous user information via the internet by entering the login and the password. Before the anonymous user information and the personal data are interlinked the customer is queried whether he or she approves to the transfer of the data form the home country to another country. If the customer approves to this procedure the limitations of data protection provisions can be bypassed. In this way a cross border data transfer can be accomplished enabling a world-wide use of the registration processes for value document owners and value documents according to the invention.

This disclosure describes a Real-Time Trading And Purchasing Of Value Documents. The first step includes providing access over the internet with an electronic device to a registry server with a registry database. Next, the disclosure provides setting up or taking over a registry for a plurality of value documents. Further included is the registration of value document owners and their value documents in an electronic log file. And, further included is keeping book entries of the plurality of registered value documents. Next, the disclosure provides that opening an e-wallet account by a buyer comprising funds and thereby defining an exit account and verifying the exit account by a control authority. Further included is the interconnecting the e-wallet, the registry and the exit account. Additionally included is the pre-order validation of all orders by blocking value documents and funds during the time period the order is pending to avoid any settlement risk for buyers and sellers. And, further included is the trading and interconnected real time settlement of funds and of one or a number of the plurality of registered value documents between the value document owner and the buyer. Additionally included is when a trade of one or a number of the plurality of registered value documents is executed, the respective book entry is updated with respect to the new owner and a confirmation document is issued to the new owner, which documents that at a date stamped he is recorded in the registry.

This disclosure further provides that where a confirmation is sent to the value document owner who as a seller sold one or a number of the plurality of registered value documents confirming his sale and the receipt of the funds in the e-wallet or directly in the exit account stamped with the date. And the disclosure further provides that after the e-wallet account is opened reconciliation with the share registry is performed and thereafter the e-wallet, the share registry and the exit account are all interconnected and trading may be performed. The disclosure further provides that when the e-wallet account is opened and activated the buyer may enter order details via a communications network.

This disclosure further includes that the value document owners are registered by recording their first name, family name, address and date of birth. The disclosure further includes that the buyer defines the exit account by providing his first name, family name, address and date of birth, and the exit account is verified by checking this data supplied by the buyer against a database of a credit validation company. And the disclosure further provides that if more than one person with the same first name is recorded in the database of the credit validation company a further age check is performed, and if the credit validation company verifies the age of the account holder, the account opening of the e-wallet account is executed.

This disclosure further includes that validated and checked orders are entered in an order book, where all buy and sell orders are consolidated for a specific price and if orders for the same price are already placed, the earlier order for the same price is first executed, then the later one. And the disclosure provides that if the order is a buy order, it is checked whether in the e-wallet there is sufficient funds and the corresponding funds are blocked, or if the order is a sell order, a check against the holdings of the seller takes place and part of the holdings corresponding to the sell order is blocked during the lifespan of the order.

This disclosure further provides that value documents are securities, securities are shares, and the registry is a share registry. Additionally, this disclosure provides that a transfer instruction for ownership change is received from a central clearing institution or directly from the shareholder and the transfer instruction is matched with the registry entries and if the transfer instruction corresponds to the registry entries the transfer instruction is executed and the share registry is updated. And, this disclosure further provides that if a match is available, the share registry is updated by reducing the shares of the seller and adding the share purchase of the buyer to his holdings in the register, and the purchase price of the transaction is debited in the e-wallet account of the buyer and credited in the account of the sellers and the confirmation documents are sent to the seller and the buyer.

This disclosure further provides that the value documents are tickets and the registry is a ticket registry. Additionally, the disclosure provides that if a match is available the ticket registry is updated by reducing the tickets of the seller and adding the ticket purchase of the buyer to his holdings in the registry, and the purchase price of the transaction is debited in the e-wallet account of the buyer and credited in the account of the sellers and the confirmation documents are sent to the seller and the buyer.

Other embodiments of the present invention will be apparent to those skilled in the art after considering this disclosure or practicing the disclosed invention. The specification and examples above are exemplary only, with the true scope of the present invention being determined by the following claims.

I claim the following invention:

1. A method for trading a plurality of value documents, comprising:
providing access over the internet with an electronic device to a registry server with a registry database;
setting up or taking over a registry for a plurality of value documents;
registration of value document owners and their value documents in an electronic log file;
keeping book entries of the plurality of registered value documents;
opening an e-wallet account by a buyer comprising funds and thereby defining an exit account and verifying the exit account by a control authority;
interconnecting the e-wallet, the registry and the exit account;
pre-order validation of all orders by blocking value documents and funds during the time period the order is pending to avoid any settlement risk for buyers and sellers;
trading and interconnected real time settlement of funds and of one or a number of the plurality of registered value documents between the value document owner and the buyer; and
wherein when a trade of one or a number of the plurality of registered value documents is executed, the respective book entry is updated with respect to the new owner and a confirmation document is issued to the new owner, which documents that at a date stamped he is recorded in the registry.

2. The claim according to claim 1 further comprising:
wherein a confirmation is sent to the value document owner who as a seller sold one or a number of the plurality of registered value documents confirming his sale and the receipt of the funds in the e-wallet or directly in the exit account stamped with the date;
wherein after the e-wallet account is opened reconciliation with the share registry is performed and thereafter the e-wallet, the share registry and the exit account are all interconnected and trading may be performed; and
wherein when the e-wallet account is opened and activated the buyer may enter order details via a communications network.

3. The claim according to claim 1 further comprising:
wherein said value document owners are registered by recording their first name, family name, address and date of birth;
wherein the buyer defines the exit account by providing his first name, family name, address and date of birth and the exit account is verified by checking this data supplied by the buyer against a database of a credit validation company; and
wherein if more than one person with the same first name is recorded in the database of the credit validation company a further age check is performed, and if the credit validation company verifies the age of the account holder, the account opening of the e-wallet account is executed.

4. The claim according to claim 1 further comprising:
wherein validated and checked orders are entered in an order book, where all buy and sell orders are consolidated for a specific price and if orders for the same price are already placed, the earlier order for the same price is first executed, then the later one; and
wherein if the order is a buy order, it is checked whether in the e-wallet there is sufficient funds and the corresponding funds are blocked, or if the order is a sell order, a check against the holdings of the seller takes place and part of the holdings corresponding to the sell order is blocked during the lifespan of the order.

5. The claim according to claim 1 wherein said value documents are securities, said securities are shares, and said registry is a share registry.

6. The claim according to claim 5 wherein a transfer instruction for ownership change is received from a central clearing institution or directly from the shareholder and the transfer instruction is matched with the registry entries and if the transfer instruction corresponds to the registry entries the transfer instruction is executed and the share registry is updated.

7. The claim according to claim 5 wherein if a match is available, the share registry is updated by reducing the shares of the seller and adding the share purchase of the buyer to his holdings in the register, and the purchase price of the transaction is debited in the e-wallet account of the buyer and credited in the account of the sellers and the confirmation documents are sent to the seller and the buyer.

8. The claim according to claim 1 wherein said value documents are tickets and the registry is a ticket registry.

9. The claim according to claim 8 wherein if a match is available the ticket registry is updated by reducing the tickets of the seller and adding the ticket purchase of the buyer to his holdings in the registry, and the purchase price of the transaction is debited in the e-wallet account of the buyer and credited in the account of the sellers and the confirmation documents are sent to the seller and the buyer.

10. The claim according to claim 1 wherein said value documents are club memberships and the registry is a membership registry.

11. A non-transitory program storage device readable by a computing device that tangibly embodies a program of instructions executable by the computing device to perform a method to use method for trading a plurality of value documents, comprising:
providing access over the internet with an electronic device to a registry server with a registry database;
setting up or taking over a registry for a plurality of value documents;
registration of value document owners and their value documents in an electronic log file;
keeping book entries of the plurality of registered value documents;
opening an e-wallet account by a buyer comprising funds and thereby defining an exit account and verifying the exit account by a control authority;
interconnecting the e-wallet, the registry and the exit account;
pre-order validation of all orders by blocking value documents and funds during the time period the order is pending to avoid any settlement risk for buyers and sellers;
trading and interconnected real time settlement of funds and of one or a number of the plurality of registered value documents between the value document owner and the buyer;
wherein when a trade of one or a number of the plurality of registered value documents is executed, the respective book entry is updated with respect to the new owner and a confirmation document is issued to the new owner, which documents that at a date stamped he is recorded in the registry.

12. The claim according to claim 11 further comprising:
wherein a confirmation is sent to the value document owner who as a seller sold one or a number of the plurality of registered value documents confirming his sale and the receipt of the funds in the e-wallet or directly in the exit account stamped with the date;
wherein after the e-wallet account is opened reconciliation with the share registry is performed and thereafter the e-wallet, the share registry and the exit account are all interconnected and trading may be performed; and
wherein when the e-wallet account is opened and activated the buyer may enter order details via a communications network.

13. The claim according to claim 11 further comprising:
wherein said value document owners are registered by recording their first name, family name, address and date of birth;
wherein the buyer defines the exit account by providing his first name, family name, address and date of birth and the exit account is verified by checking this data supplied by the buyer against a database of a credit validation company; and
wherein if more than one person with the same first name is recorded in the database of the credit validation company a further age check is performed, and if the credit validation company verifies the age of the account holder, the account opening of the e-wallet account is executed.

14. The claim according to claim 11 further comprising:
wherein validated and checked orders are entered in an order book, where all buy and sell orders are consolidated for a specific price and if orders for the same price are already placed, the earlier order for the same price is first executed, then the later one; and
wherein if the order is a buy order, it is checked whether in the e-wallet there are sufficient funds and the corresponding funds are blocked, or if the order is a sell order, a check against the holdings of the seller takes place and part of the holdings corresponding to the sell order are blocked during the lifespan of the order.

15. The claim according to claim 11 wherein said value documents are securities, said securities are shares, and said registry is a share registry.

16. The claim according to claim 15 wherein a transfer instruction for ownership change is received from a central clearing institution or directly from the shareholder and the transfer instruction is matched with the registry entries and if the transfer instruction corresponds to the registry entries the transfer instruction is executed and the share registry is updated.

17. The claim according to claim 15 wherein if a match is available, the share registry is updated by reducing the shares of the seller and adding the share purchase of the buyer to his holdings in the register, and the purchase price of the transaction is debited in the e-wallet account of the buyer and credited in the account of the sellers and the confirmation documents are sent to the seller and the buyer.

18. The claim according to claim 11 wherein said value documents are tickets and the registry is a ticket registry.

19. The claim according to claim 18 wherein if a match is available the ticket registry is updated by reducing the tickets of the seller and adding the ticket purchase of the buyer to his holdings in the registry, and the purchase price of the transaction is debited in the e-wallet account of the buyer and credited in the account of the sellers and the confirmation documents are sent to the seller and the buyer.

20. The claim according to claim 11 wherein said value documents are club memberships and the registry is a membership registry.
